(19) United States
(12) Patent Application Publication
(10) Pub. No.: US 2017/0285903 A1
(43) Pub. Date: Oct. 5, 2017

(54) VIRTUAL MAGNETIC MANAGEMENT OF GRAPHICAL CONTENT

(71) Applicant: SMART TECHNOLOGIES ULC, Calgary (CA)

(72) Inventors: Nghiep Duy Duong, Sammamish, WA (US); Brian Heath Ward, Seattle, WA (US)

(21) Appl. No.: 15/084,294

(22) Filed: Mar. 29, 2016

(51) Int. Cl. G06F 3/0488; G06F 3/0486; G06F 3/0484

(52) U.S. Cl. CPC G06F 3/0488; G06F 3/04842; G06F 3/0486

(57) ABSTRACT

A method for virtual magnetic management of graphical content can include associating the graphical content with a digital object. First attraction properties are associated with the digital object. Second attraction properties are associated with a graphical tool for managing digital objects. Attraction between the digital object and the graphical tool can be detected based on the first and second attraction properties. If the attraction is detected, the digital object and the graphical tool are displayed as attached to one another at a display area. If no attraction is detected, the digital object and the graphical tool are displayed as detached from one another.

### TECHNICAL FIELD

The disclosed embodiments relate generally to display systems configured to display graphical content, and, in particular, to managing the display of content in a manner that at least partially simulates the behavior of physical magnets and/or electromagnets.

### BACKGROUND

Display systems typically include a display and optionally input devices. An interactive display system (“interactive system”) can include as an input device a touchscreen having an interactive surface onto which digital content is presented. Users can interact with the system using the touchscreen, e.g., to provide input. The interactive system can detect pointer interactions between the touchscreen surface and a pointing device, such as a pen tool, or a user's finger or hand. Content can be erased, modified, or added based on the pointer interactions.

One type of content that users can create are digital notes. Digital notes can be text and images that the user creates using notetaking software, such as Evernote®. The notetaking software allows the user to edit, annotate, and tag the digital notes. Traditional software for creating and organizing digital notes allows users to archive and search for digital notes based on subject, author, creation date, or tag. One challenge in traditional notetaking software is that it is difficult to organize the digital notes, especially in cases where there is a large archive of notes. As the archive of content grows, it becomes increasingly difficult for the user to effectively organize the content based on textual identifiers, such as tags.

### BRIEF DESCRIPTION OF THE DRAWINGS

FIG. 1 is a block diagram illustrating an overview of an environment in which a system configured for virtual magnetic management of graphical content can be implemented.

FIG. 2 is a block diagram illustrating components of a computing device in which aspects of virtual magnetic management of graphical content can be implemented.

FIGS. 3A-6E are display diagrams illustrating digital objects and graphical tools in some implementations for magnetic management of graphical content.

FIGS. 7A-7C are various flow diagrams illustrating processes used in some implementations for magnetic management of graphical content.

### DETAILED DESCRIPTION

Embodiments are described for virtual magnetic management of graphical content. In various embodiments, a method for virtual magnetic management can include associating the graphical content and first attraction properties with a digital object. The method further includes associating second attraction properties with a graphical tool for managing digital objects. Attraction between the digital object and the graphical tool can be detected based on the first and second attraction properties. If the attraction is detected, the digital object and the graphical tool are displayed as attached to one another at a display area. If no attraction is detected, the digital object and the graphical tool are displayed as detached from one another.

In some embodiments, a computing system can display the digital object in the form of virtual magnet, and the graphical tool in the form of a virtual electromagnet. The electromagnet can be selectively activated into an energized state and de-activated into a de-energized state. The magnet can attach to the electromagnet when it is energized, but will detach from the electromagnet when it is de-energized. In some embodiments, the magnet can be magnetized and de-magnetized by the user. When magnetized, the magnet can attach to the electromagnet. When de-magnetized, the magnet will not attach to the electromagnet, even when the electromagnet is energized. In various embodiments, virtual magnets and electromagnets can facilitate organization of the various graphical content at a digital canvas.

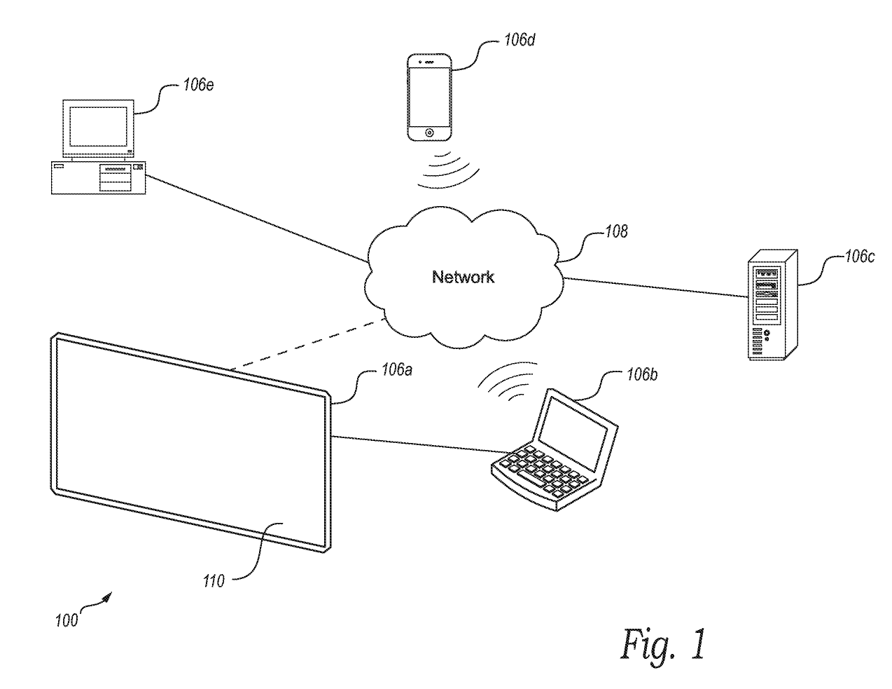

Various details are set forth in the following description, FIGS. 1-7C provide a thorough understanding of various embodiments of the disclosed technology. Other details describing well-known structures, systems, and methods, however, are not set forth below to avoid unnecessarily obscuring the description of the various embodiments of the technology. In the Figures, identical reference numbers identify at least generally similar elements.

FIG. 1 is a block diagram illustrating an overview of an environment in which a system 100 configured for virtual magnetic management of graphical content can be implemented. The system 100 includes a display device 106a having a display area 110. The display device 106a can include, for example, a conventional display device, such as a touchscreen, a video projector, an LCD or LED display, or the like. In some embodiments, the display device 106a can be an interactive display that receives user input via pointer interactions with the display area 110 via a pen tool or direct contact with a presenter's finger(s) or hand. An interactive display can include, for example, Smart kapp IQ™, Smart kapp IQ Pro™, Smart Board 4000 series, or a Smart Board 6000 series display available from assignee SMART Technologies, ULC of Calgary, Alberta, Canada. In various embodiments, the interactive displays can include an interactive display or system described in U.S. Pat. Nos. 5,448,263; 6,141,000; 6,337,681; 6,747,636; 6,803,906; 7,236,162; 7,232,986; 7,274,356; and 8,456,451, all assigned to SMART Technologies ULC, and all of which are incorporated by reference herein in their entireties. The display device 106a is configured to present various graphical content, as described in greater detail below.

In the illustrated embodiment, the display device 106a is operably coupled to a computing device 106b. The computing device 106b is, in turn, connected to other computing devices 106c-e through a network 108. The display device 106a and the computing devices 106b-e can enable users to receive, view, store, and/or otherwise interact with graphical content that has been presented at the display area 110. In some embodiments, the display device 106a can operate as a stand-alone computing device, and the intermediary computing device 106b can be omitted. Examples of well-known computing devices, systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, databases, distributed computing environments that include any of the above systems or devices, or the like.

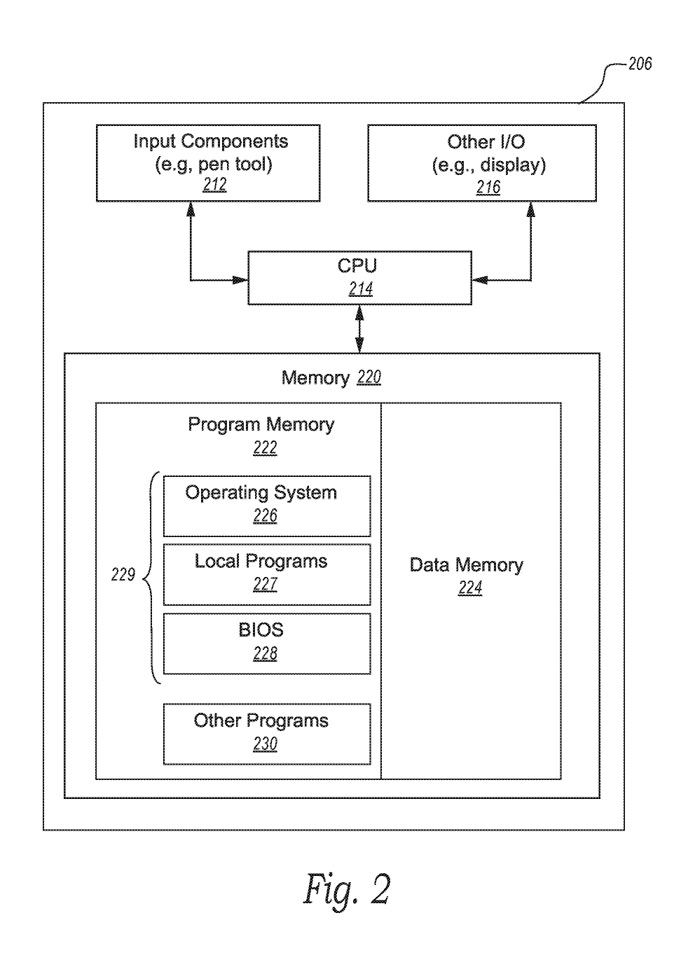

FIG. 2 is block diagram illustrating components of a computing device 206, such as the display device 106a (FIG. 1). The computing device 206 includes input components 212 configured to provide input to a processor, or CPU 214, notifying it of actions. The actions are typically mediated by a hardware controller that communicates according to one or more communication protocols. The input components 212 can include, for example, a mouse, a keyboard, a touchscreen, an infrared sensor, a touchpad, a wearable input device, a pointer device, a camera- or image-based input device, a pointer, and/or one or more microphones.

The CPU 214 can be a single processing unit or multiple processing units in a device or distributed across multiple devices. The CPU 214 can be coupled to other hardware components via, e.g., a bus, such as a PCI bus or SCSI bus. Other input/output components 216 include communication components, such as a wireless transceiver (e.g., a WiFi or Bluetooth transceiver) and/or a network card. Such communication components can enable communication over wired or wireless (e.g., point-to point) connections with other devices. A network card can enable the computing device 206 to communicate over the network 108 (FIG. 1) using, e.g., TCP/IP protocols. The input/output components 216 may also include a display, a video card, audio card, USB, firewire or other external components or devices, such as a camera, printer, CD-ROM drive, DVD drive, disk drive, Blu-Ray device, and/or speakers.

The CPU 214 can have access to a memory 220. The memory 220 includes volatile and non-volatile components which may be writable or read-only. For example, the memory can comprise CPU registers, random access memory (RAM), read-only memory (ROM), and writable non-volatile memory, such as flash memory, hard drives, floppy disks, CDs, DVDs, magnetic storage devices, tape drives, device buffers, and so forth. The memory 220 stores programs and software in programming memory 222 and associated data (e.g., configuration data, settings, user options or preferences, etc.) in data memory 224. The programming memory 222 contains an operating system 226, local programs 227, and a basic input output system (BIOS) 228, all of which can be referred to collectively as general software 229. The programming memory 222 also contains other programs and software 230, including specialized programs and software configured to perform various operations for presenting graphical content at the display area 110 (FIG. 1) as described in greater detail below.

Those skilled in the art will appreciate that the components illustrated in FIGS. 1 and 2 described above, and in each of the diagrams discussed below, may be altered in a variety of ways. For example, the order of the logic may be rearranged, substeps may be performed in parallel, illustrated logic may be omitted, other logic may be included, etc. For example, blocks shown in dashed lines may be excluded from some implementations. However, applicants do not intend to say that only blocks shown in dashed lines may be excluded from some implementations

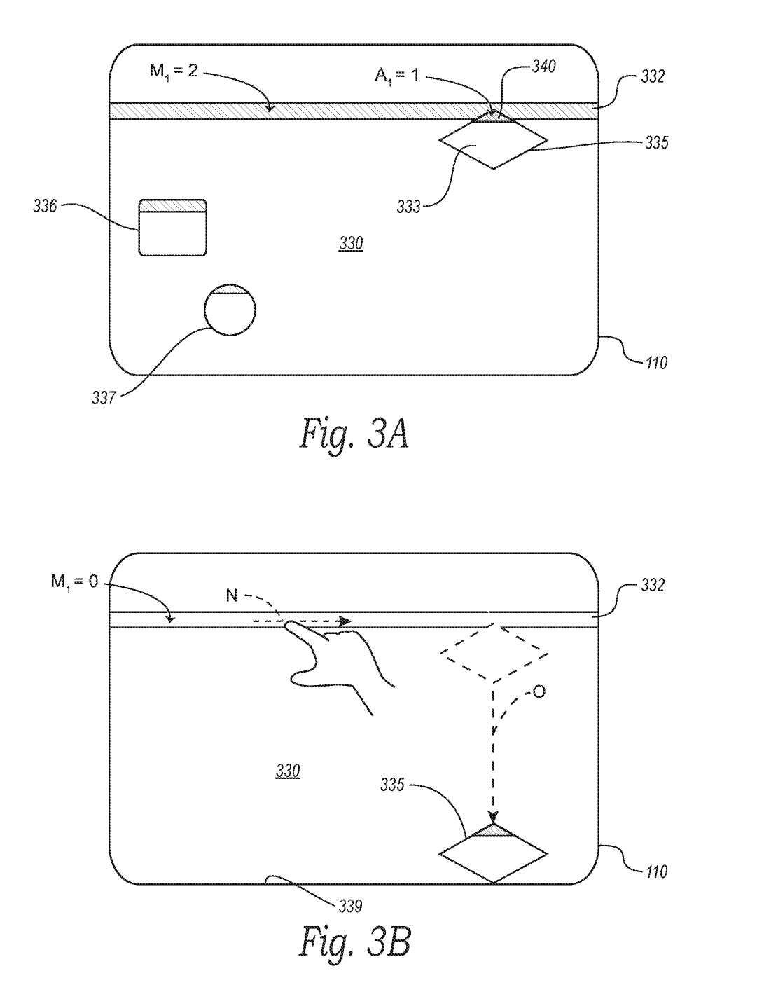

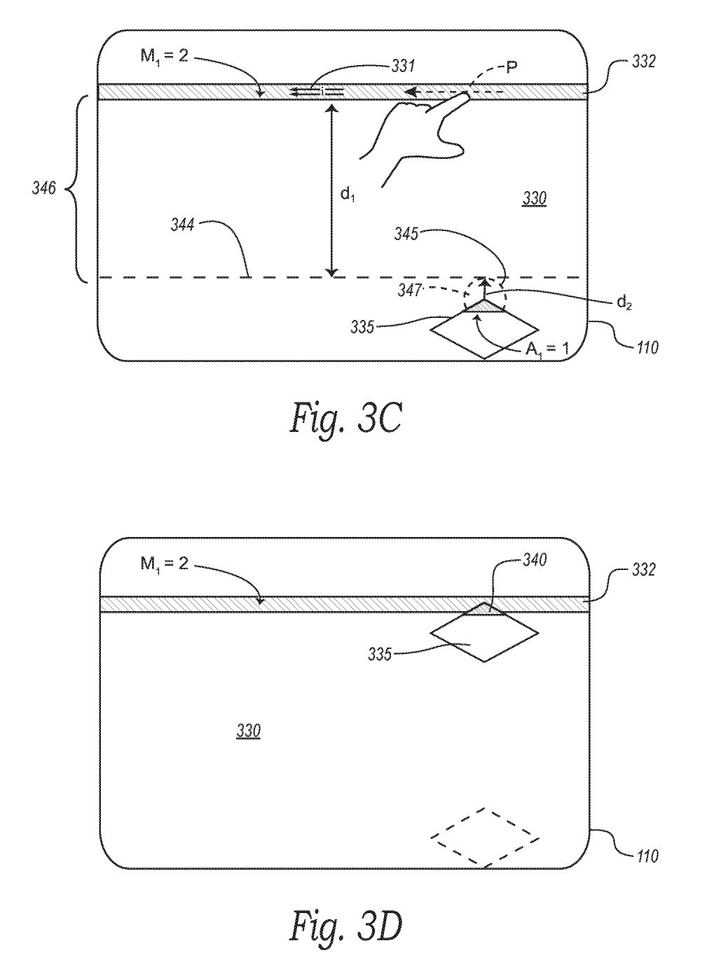

FIGS. 3A-3D are display diagrams illustrating digital objects and a graphical tool configured to “magnetically” manage the digital objects on a digital canvas 330 presented at the display area 110. In the present application the terms “magnet”, “magnetic”, “electromagnetic,” and the like are used in the sense that the interaction of digital objects in a virtual environment that at least partially simulates the physical behavior of magnets or electromagnets and ferromagnetic materials being attracted to or repelled from one another in the real world. Referring to FIG. 3A, the graphical tool is in the form of a virtual electromagnet 332 (“electromagnet 332”) that extends horizontally across the canvas 330 toward the top of the display area 110. In various embodiments, the user can set the position and orientation of the electromagnet 332. For example, the user can rotate the electromagnet 332, change its horizontal and/or vertical position, and/or expand/decrease its size. As described below, the user can also add (and remove) additional electromagnets to (and from) the canvas 330.

A digital object in the form of a virtual magnet 335 (“magnet 335”) is displayed on the canvas 330 and adjacent the electromagnet 332. In this example, the electromagnet 332 is in the shape of a rectangular bar or strip, and the magnet 335 is a sticky note having a diamond shape. In other embodiments, digital objects can have other shapes, sizes, patterns, or other features (e.g., user-selectable colors, patterns, and shapes; interactive buttons; etc.). For example, other digital objects on the canvas 330 can include a square magnet 336 and/or a circular magnet 337.

A user can interact with the magnet 335 and the electromagnet 332 using an input device (e.g., a mouse, keyboard, pen tool, touchscreen, etc.) or a finger. In some embodiments, users can share digital objects with other users over the network 108 (FIG. 1). The magnet 335 includes an attachment region 340 and a content region 333. The content region 333 contains graphical content (not shown), such as an image, text, a video, an animation, an attachment, a document, a file, a hyperlink (to, e.g., a webpage, an embedded file, etc.), and/or any other information suitable for display. A user can add, edit, or delete graphical content through writing, drawing, attaching, or performing other operations (e.g., cut and paste).

In operation, the technology associates attraction properties with digital object(s) (e.g., the magnets 335-337) and graphical tool(s) (e.g., the electromagnet 333). The technology detects for attraction between a digital object and a graphical tool based on the attraction properties. As described below, attraction can be detected, for example, based on attachment strengths, attachments fields, distance between digital objects and graphical tools, and/or polarities of attraction assigned to the various objects and tools. In one aspect, the attraction facilitates visual organization of graphical content. In another aspect, the technology implements digital objects and graphical tools in a way that selectively mimics aspects of magnetic attraction and repulsion. In various embodiments, digital objects and graphical tools emulate magnetic characteristics, but do not attempt to model exact magnetic behavior. For example, in the embodiments described below, a magnet does not directly interact with other magnets (e.g., with the magnetic fields of other magnets). In other embodiments, however, the magnets can exhibit behavior that more closely models exact magnetic behavior. For example, in some embodiments, the magnets can be configured to attract to one another based on a field strength.

The electromagnet 332, when energized, can at least temporarily hold a magnet, such as the magnet 335, to facilitate organization of the various graphical content at the canvas 330. In another aspect, the technology facilitates brainstorming, ideation, and collaboration, such as during a live collaboration session when multiple users may manipulate content. For example, the electromagnet 332 can prevent the magnet 335 from being inadvertently moved while a user manipulates or otherwise works with the other magnets 336-337 and their associated content. In yet another aspect, the technology enables a user to visually organize content without the use of tags or other textual identifiers.

In the illustrated embodiments, the attraction properties of the magnet 335 and the electromagnet 332 include attachment strengths. In various embodiments, the magnet 335 and the electromagnet 332 can be displayed with specific colors, levels of brightness, shapes, patterns, and/or other features that provide a visual indication of their corresponding attachment strength. For example, a level of attachment strength can be represented by the color blue, while a different level of attachment strength can be represented by a brighter/darker blue or a different color.

In the below examples, attachment strengths are represented by designated patterns that fill the magnet 335 and the electromagnet 332. For example, in FIG. 3A, an attachment region 340 of the magnet 335 is filled with a designated pattern indicating an attachment strength of A₁=1, while the entire area of the electromagnet 332 is filled with a different designated pattern indicating an attachment strength of M₁=2. The level of the attachment strengths can be represented by a numerical value such as an integer value, with a larger value indicating a greater magnitude of attachment strength. For example, in the case of the magnet 335, an attachment strength of A₁=2 is greater than an attachment strength of A₁=1. A non-zero attachment strength of A₁≠0 can be referred to as a de-magnetized state, while a non-zero attachment strength can be referred to as a magnetized state. The electromagnet 332 has an attachment strength M₁ represented by another numerical value which may be an integer value in a similar manner. A non-zero attachment strength of M₁≠0 can be referred to as a de-energized state, while a non-zero attachment strength can be referred to as an energized state. While in the illustrated embodiment, the various attachment strengths are represented as whole number, in other embodiments attachment strengths can be represented as decimal numbers and/or other values.

Detection of attraction between the magnet 335 and the electromagnet 332 can based at least in part on the attachment strengths A₁ and M₁, as described below. When attraction is detected, the magnet 335 is displayed as being attached to the electromagnet 332 (e.g., adjacent and/or overlapping the electromagnet 332), as shown in FIG. 3A. When attraction is not detected, the magnet 335 is displayed as being detached from the electromagnet 332, as shown in FIG. 3B. In the example of FIG. 3B, the electromagnet 332 is in a de-energized state (i.e., M₁=0). In some embodiments, the electromagnet 332 can be de-energized when the user makes a swiping gesture on the display area 110 near the electromagnet 332, such as in the left-to-right direction, as shown by arrow N. When de-energized, the electromagnet 332 can appear blank, i.e., filled with a solid color (e.g., white) and not filled with a pattern.

In response to the de-energization of the electromagnet 332, the magnet 335 detaches from the electromagnet 332 and falls towards a floor region 339 near the bottom of the canvas 330, as shown by arrow O. In some embodiments, the magnet 335 can disappear from the display area 110 rather than fall to the floor region 339. Magnets that have disappeared may be permanently deleted, or they may be saved so that a user can recall the magnet at a later time (e.g., for organizing, editing, or deletion).

FIG. 3C shows the electromagnet 332 in an energized state after being de-energized in FIG. 3B. In this particular energized state, the electromagnet 332 is restored to its original energized state in which the attachment strength is M₁=2. In some embodiments, the electromagnet 332 can be energized when the user makes a swiping gesture on the display area 110 near the electromagnet 332, such as in the right-to-left direction, as shown by arrow P. For example, a first swipe in the right-to-left direction can increase the attachment strength from M₁=0 to M₁=1. A second swipe following the first swipe in the same direction can increase the attachment strength from M₁=1 to M₁=2. A swipe in the opposite direction can decrease the attachment strength in a similar manner (e.g., from M₂=2 to M₁=1). In some embodiments, a graphic of an electrical current 331 can temporarily appear on the electromagnet 332 when it is first energized and/or when the user increases/decreases its attachment strength.

FIG. 3C also shows additional attachment properties of the electromagnet 332 and the magnet 335. These attachment properties include attachment fields 346 and 347 associated with the electromagnet 332 and the magnet 335, respectively. The attachment fields 346-347 may not typically be displayed on the canvas 330, but are shown in FIG. 3C for purposes of illustration. When the electromagnet 332 is energized, the attachment field 346 emanates from the perimeter of the electromagnet 332 by a distance d₁. In the illustrated embodiment, the attachment field 346 has a boundary 344 with a generally rectangular shape on the canvas 330. In other embodiments, the attachment field 346 can have a different shape, such as an ovular, circular, triangular, parabolic, or other shape. In various embodiments, the shape of an attachment field can be dictated by the shape of the object from which the field emanates.

When the magnet 335 is magnetized, the associated attachment field 347 emanates from the attachment region 340 by a distance d₂. The attachment field 347 has boundary 345 that covers a generally circular area on the canvas 330. The size of the boundaries 344-345 areas are generally correlative with the magnitude of the corresponding attachment strengths A₁ and M₁. Hence, a greater attachment strength will provide an attachment field that covers a relatively larger area on the canvas 330 (and vice versa).

The magnet 335 is attracted to the electromagnet 332 when the boundary 345 of its attachment field 347 extends at least to the boundary 344 of the attachment field 346 of the electromagnet 332. The attraction causes the magnet 335 to attach (e.g., snap) to the electromagnet 332, as shown in FIG. 3D.

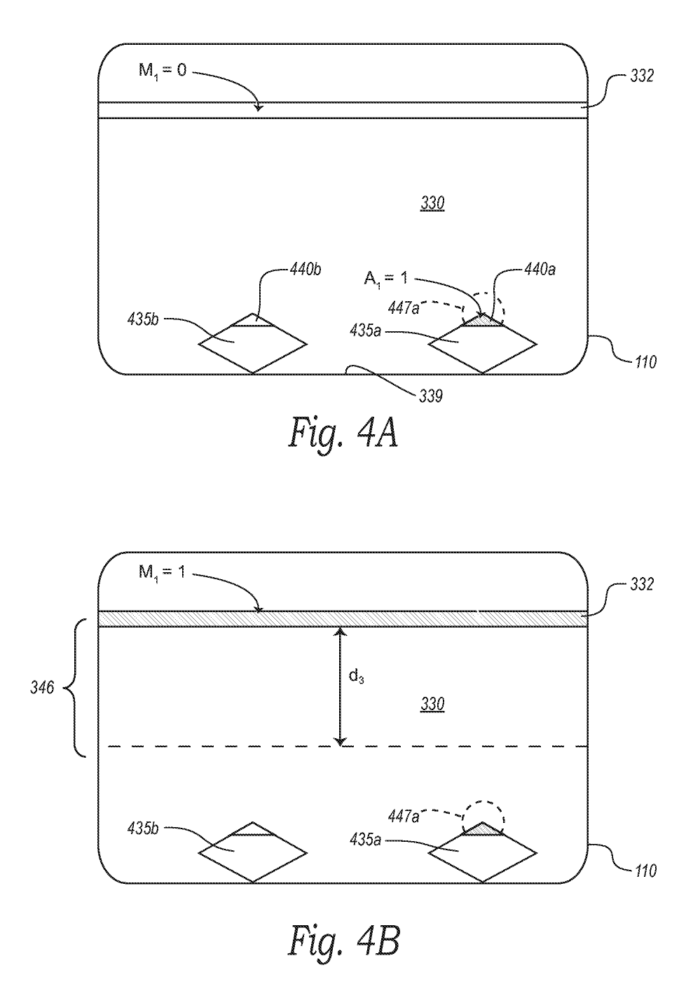

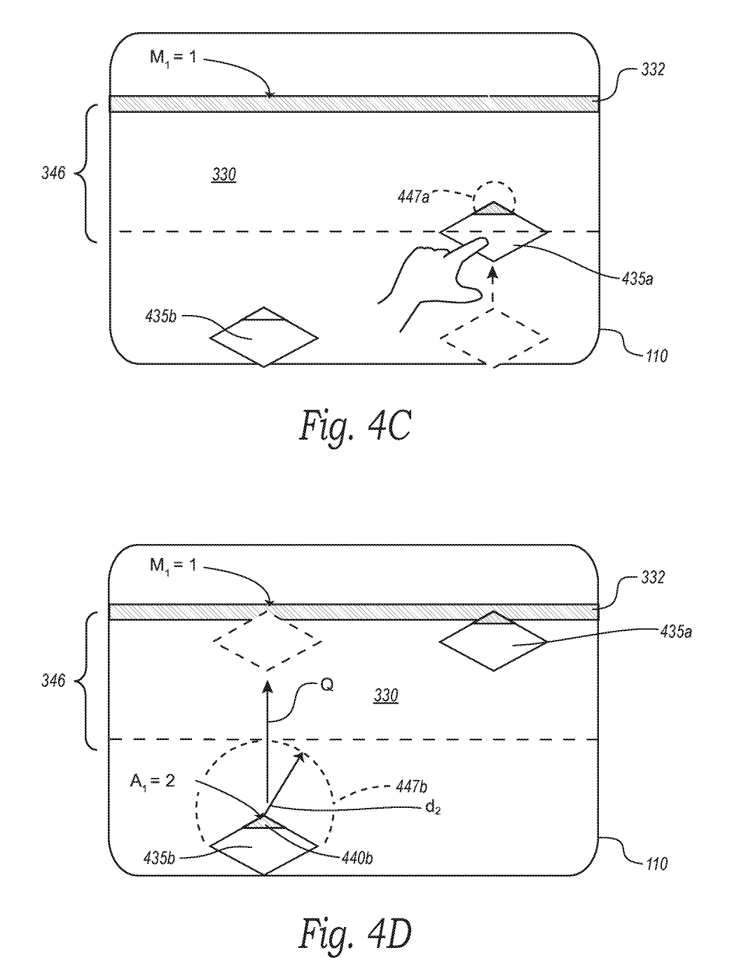

FIGS. 4A-4D are display diagrams illustrating digital objects in the form of a first virtual magnet (“first magnet 435a”) and a second virtual magnet (“second magnet 435b”). Referring to FIG. 4A, the electromagnet 332 is in a de-energized state, and the magnets 435 are both displayed at the floor region 339 of the canvas 330. The magnets 435 are similar to the magnet 335 described above with reference to FIGS. 3A-3D. For example, each of the magnets 435 is configured to store graphical content (not shown) and includes an attachment region 440 (identified individually as a first attachment region 440a and a second attachment region 440b). In FIG. 4A, the first magnet 435a has an attachment strength of A₁=1 and a corresponding attachment field 447a. The second magnet 435b is in de-magnetized state. This is represented by the attachment region 440b appearing blank. Because the second magnet 435b is de-magnetized, an attachment field does not emanate from its perimeter.

FIG. 4B shows the electromagnet 332 after it has been energized from its de-energized state shown in FIG. 4B. In this example, the electromagnet 332 has an attachment strength M₁=1. At this attachment strength, the attachment field 346 of the electromagnet 332 emanates to a distance d₃. The distance d₃ is less than distance d₁ shown in FIG. 3C due to the weaker attachment strength of M₁. As shown, the attachment field 346 does not extend to the boundary of the attachment field 447a of the first magnet 435a. Accordingly, the first magnet 435a does not attach to the electromagnet 332. The second magnet 435b does not attach because it is de-magnetized.

FIG. 4C shows the first magnet 435a after a user has dragged it from its position in FIG. 4B to a position located within the attachment field 346 of the electromagnet 332. Accordingly, attraction of the first magnet 435a to the electromagnet 332 is detected due to the overlap of the attachment field 346 with the attachment field 447a of the first magnet 435a. This, in turn, causes the first magnet 435a to attach (e.g., snap) to the electromagnet 332, as described above. In some embodiments, the user can make a swipe gesture (e.g., a “flick” gesture) on the display area 110 that “throws” the first magnet 435a toward the electromagnet 332.

FIG. 4D shows the second magnet 435b after it has been magnetized from its de-magnetized state shown in FIG. 4C. In this example, the second magnet 435b has an attachment strength A₂=2. At the attachment strength A₂=2, the second magnet 435b has an attachment field 447b that emanates a distance d₂ and reaches the boundary of the attachment field 346 of the electromagnet 332. Accordingly, the second magnet 435b automatically attaches to the electromagnet 332, as shown by arrow Q.

In some embodiments, a user can change the attachment strength (and thereby magnetize/demagnetize) of a magnet by touching the corresponding attachment region, e.g., via a finger or pointer device, for a predetermined time without moving the magnet. For example, touching the attachment region 440b of the second magnet 435b for a first duration of two seconds may increment the attachment strength from A₂=0 to A₂=1. Continuing to touch the attachment region for a second duration (e.g., an additional two seconds) can further increment the attachment strength from A₂=1 to A₂=2. The user may decrement the attachment strength in a similar manner by touching a different portion (e.g., the content region) of the second magnet 335b for a predetermined duration of time and without moving the magnet. The lack of movement while touching can be distinguished by the system from other user gestures on the display area 110, such as swipe gestures.

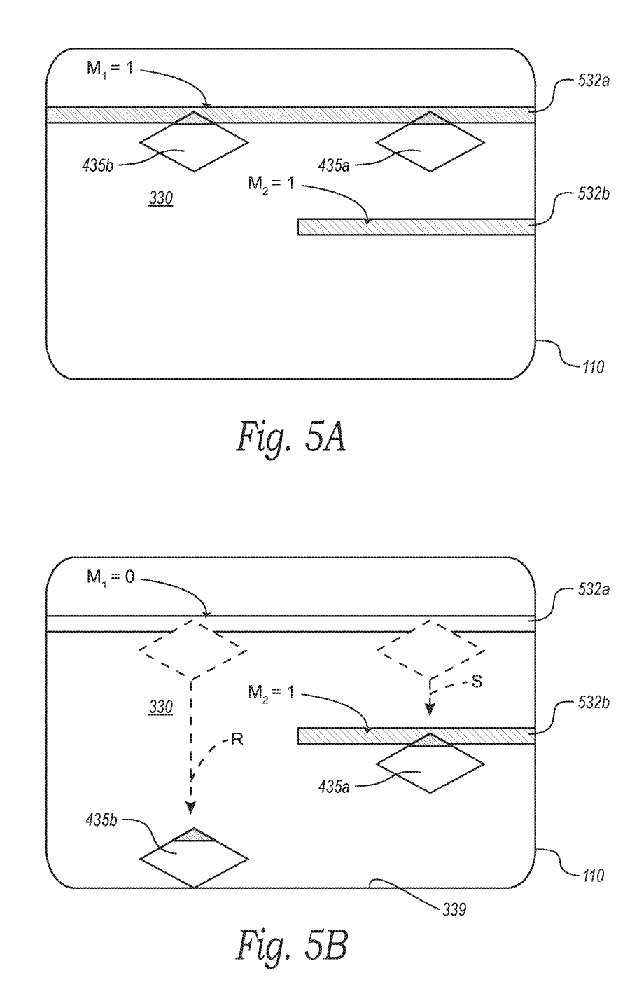

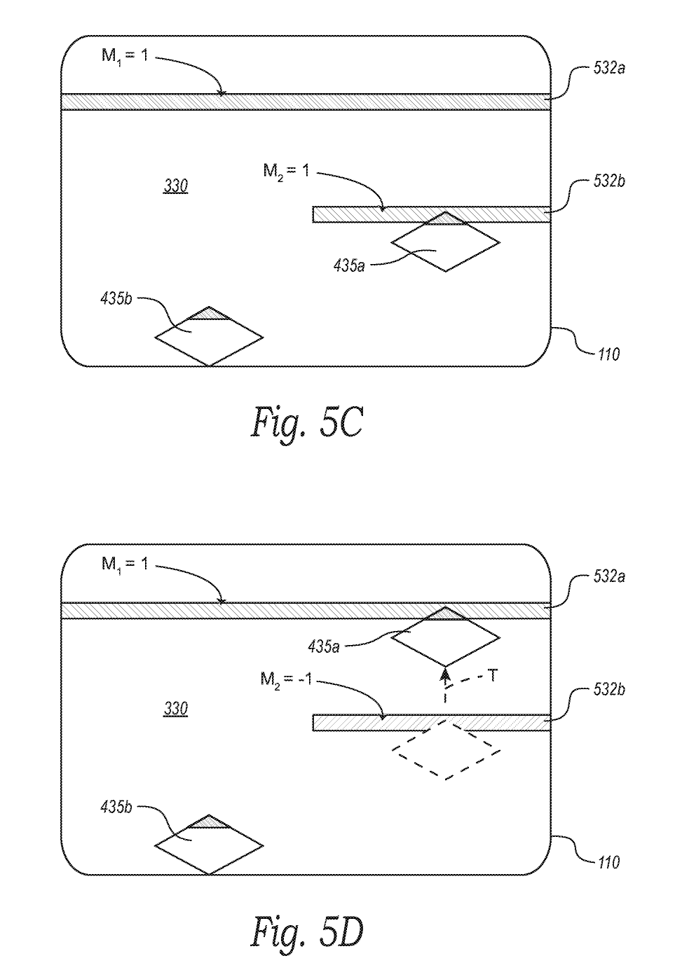

FIGS. 5A-5E are display diagrams illustrating graphical tools in the form of a first virtual electromagnet 532a (“first electromagnet 532a”) and a second virtual electromagnet 532b (“second electromagnet 532b”). Referring to FIG. 5A, the magnets 435 are attached to the first electromagnet 532a. The first electromagnet 532a extends across the canvas 330 in a manner similar to the electromagnet 332 described above. The second electromagnet 532b is beneath the first electromagnet 532a and extends halfway across the canvas 330 from the right side. Both of the electromagnets are energized. The first electromagnet 532a has an attachment strength M₁=1, and the second electromagnet 532b has an attachment strength M₂=1.

FIG. 5B shows the first electromagnet 532a after it has been de-energized from its energized state shown in FIG. 5A. In response to the de-energization, both the magnets 435 fall toward the floor region 339, as shown by arrows R and S. As the magnets fall, the first magnet 435a is attracted to the second electromagnet 532b. The second magnet 435b, however, falls to the floor region 339 because the attachment field (not shown) of the second magnet 435b is not within the range of the attachment field (not shown) of the second electromagnet 532b.

FIG. 5C shows the first electromagnet 532a after it has been re-energized form its de-energized state shown in FIG. 5B. Although the first electromagnet has been re-energized, the first magnet 435a remains attached to the second electromagnet 532b because the second electromagnet 532b has the same level of attachment strength M₂ as the attachment strength M₁ of the first electromagnet 532a. In some embodiments, the user can move the first magnet 435a back onto the first electromagnet 532a via, e.g., a flick gesture, to overcome the attraction force holding the first magnet 435a to the second electromagnet 532b. In various embodiments, the appearance of the electromagnets allows the user to prioritize content. For example, the user can place higher priority content on the first electromagnet 532a and lower priority content on the second electromagnet 532b.

FIG. 5D shows the second electromagnet 532b after reversing the polarity of the attachment strength M₂ shown in FIG. 5C. In this example, the attachment strength is reversed to M₂=−1. The reverse polarity repels the first magnet 435a back toward the first electromagnet 532a, as shown by arrow T. FIG. 5E shows the second electromagnet 532b with the polarity reversed again and increased to attachment strength M₂=2. The relatively larger attachment strength M₂>M₁ causes the first magnet 435a to detach from the first electromagnet 532a and re-attach to the second electromagnet 532b, as shown by arrow U.

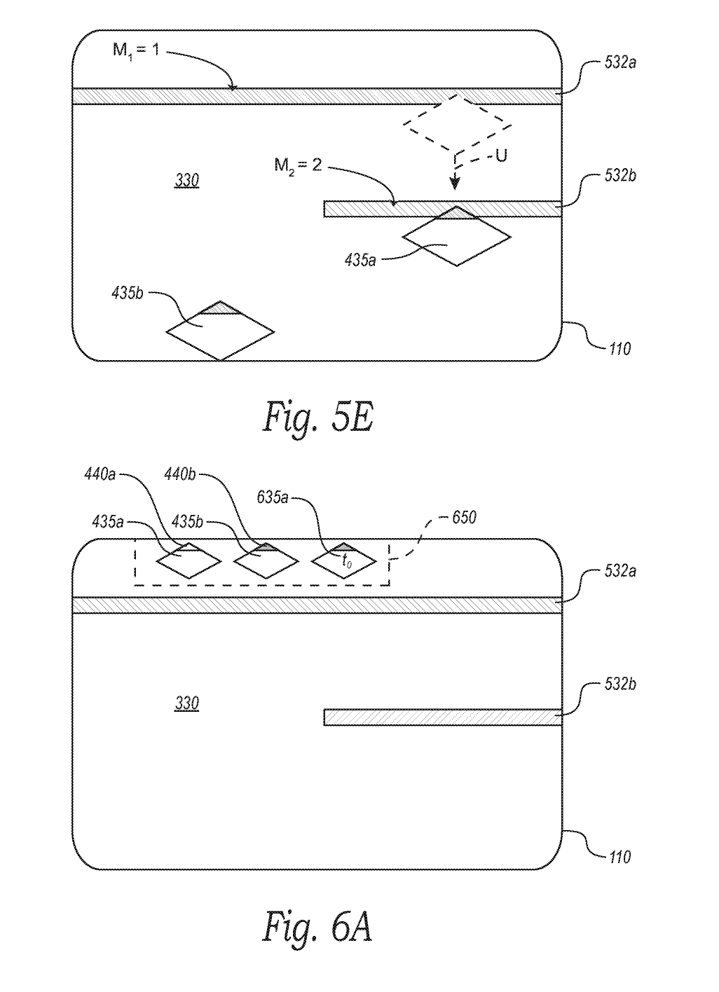

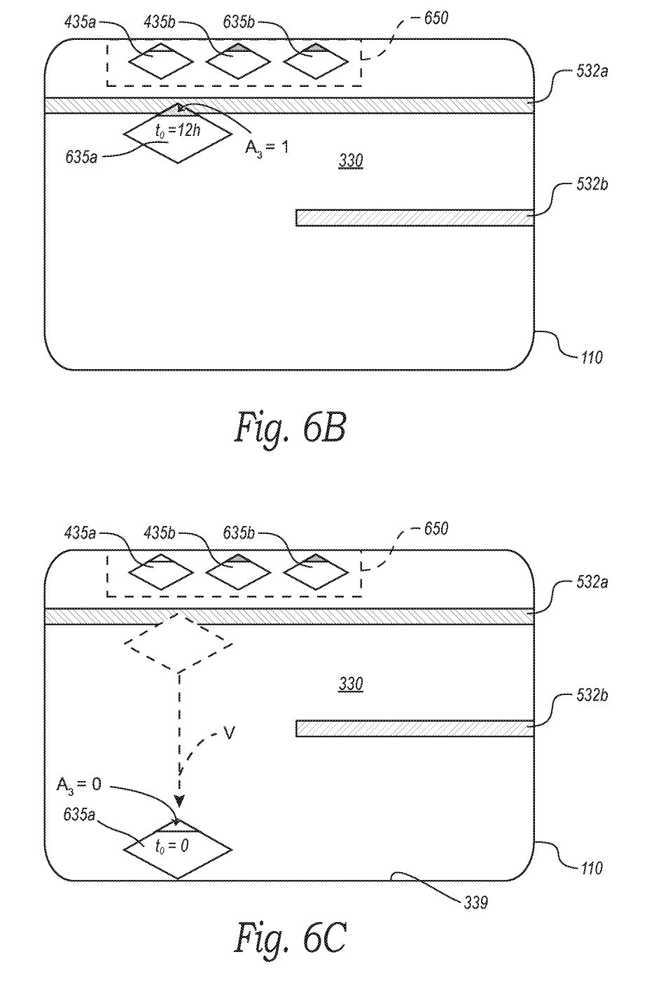

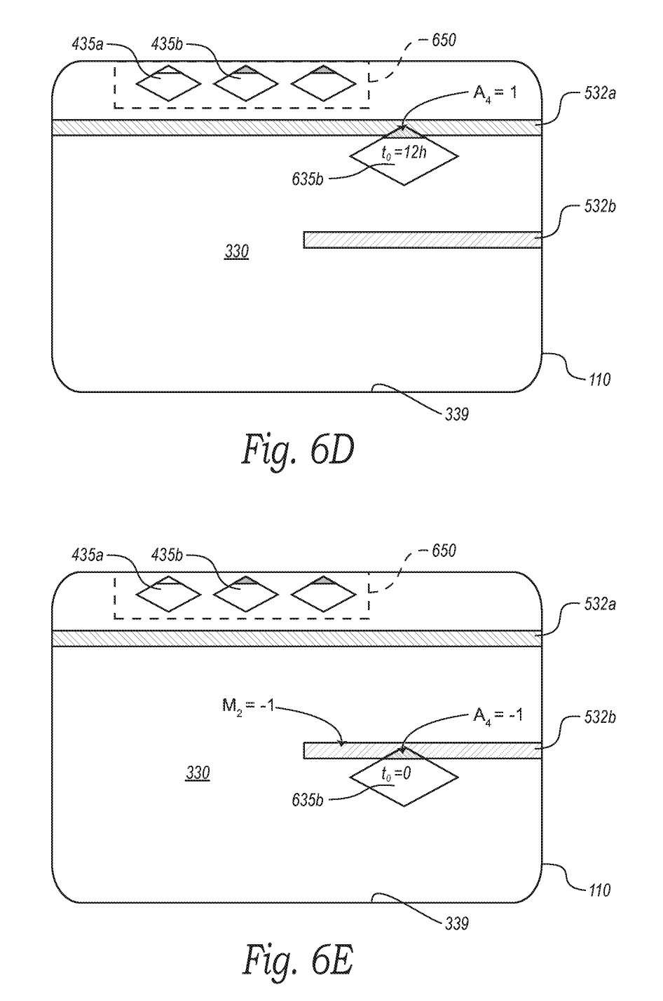

FIGS. 6A-6E are display diagrams showing a graphical slide-out bar 650 on the canvas 330 above the first electromagnet 532a. Referring to FIG. 6A, the slide-out bar 650 includes a plurality of digital objects in the form of virtual magnets having predetermined attraction properties. In some embodiments, the slide-out bar 650 can appear when the user touches a portion of the display area 110 above the first electromagnet 532a. In the example of FIG. 6A, the slide-out bar 650 includes the first magnet 435a, the second magnet 435b, and a third virtual magnet 635a (“third magnet 625a”). In use, the user can drag the magnets contained in the slide-out bar 650 over to open areas of the canvas 330 and/or onto one of the electromagnets 532.

With reference still to FIG. 6A, the first magnet 435a is assigned to a de-magnetized state by default, the second magnet 435b, is assigned to a to a magnetized state by default, and the third magnet 635a is assigned to a magnetized state with an associated time value, t₀, that corresponds to an expiration time. When the expiration time expires, the attachment strength of the third magnet 635a will change (e.g., decrease, reverse polarity, etc.). In some embodiments, the time values can correspond to a number in units of minutes, hours, days, months, etc. Alternately, the time value t₀ can correspond to a specific date and/or time of the day at which the third magnet 635a will expire. In various embodiments, assigning expiration times to magnets can prevent the electromagnets 532 from becoming cluttered as other magnetics are added over time.

FIG. 6B shows the third magnet 635a after the user has dragged it onto the first electromagnet 532a. A fourth virtual magnet 635b (“fourth magnet 635b”) can appear in the slide-out bar 650 at the former location of the third magnet 635a. In the example of FIG. 6B, the time value t₀ is set to 12 hours and begins to count down when the third magnet 635a is first attached to the first electromagnet 532a.

FIG. 6C shows the third magnet 635a after it has expired. Upon expiration, an attachment strength of the magnet changes from A₃=1 (FIG. 6B) to A₃=0. Accordingly, the third magnet 635a de-magnetizes and falls to the floor region 339, as shown by arrow V.

FIG. 6D shows the fourth magnet 635b after the user has dragged it onto the first electromagnet 532a at a location above the second electromagnet 532b. In this example, the fourth magnet 635b will fall to the second electromagnet 532b rather than the floor region 339 upon expiration, as shown in FIG. 6E. In some embodiments, the expiration of the fourth magnet 635b can change the polarity of attachment strength, e.g., from A₄=1 (FIG. 6D) to A₄=−1. This causes the first electromagnet 532a to repel the fourth magnet 635b. The fourth magnet 635b can attach to the second electromagnet 532b when it has the same polarity of attachment strength (e.g., M₂=−1).

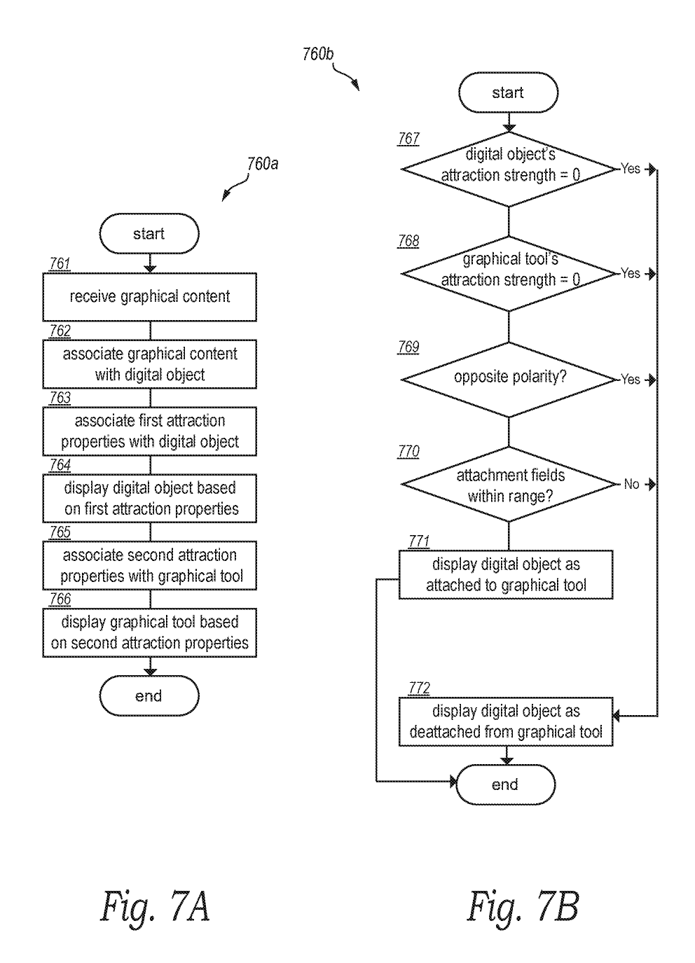

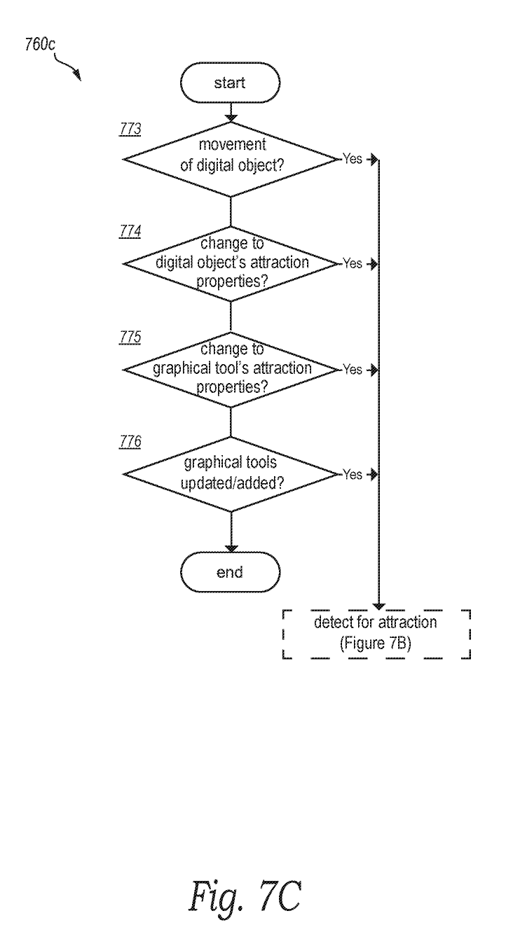

FIGS. 7A-7C are flow diagrams illustrating first, second, and third processes 760a-760c, respectively, for virtual magnetic management of graphical content at a display area (e.g., the display area 110; FIG. 1). Referring to FIG. 7A, the first process 760a can be used to create and/or modify digital objects and graphical tools, such as a virtual magnets and electromagnets. At block 761, the process 760a receives graphical content for display, such as text, images, or other content, as discussed above. At block 762, the process 760a associates the graphical content with a digital object. In some embodiments, the process 760a can display the graphical content in a virtual magnet's content region.

At block 763, the process 760a associates one or more first attraction properties with the digital object. The first attraction properties can include, for example, an attachment strength (e.g., a magnetization state), an attachment field, a polarity, and/or other properties (e.g., a time value). As described above, the size of an attachment field can be associated with the magnitude of an attachment strength. The location of the attachment field can be based on the location of the digital object once placed at the display area. At block 764, the process 760a displays the digital object based on the first attraction properties. For example, the entire digital object or portion(s) of the digital object (e.g., an attachment region) can change in color, pattern, shape, and/or in other ways based on the attraction properties.

At block 765, the process 760a associates one or more second attraction properties with a graphical tool. The second attraction properties can include, for example, an attachment strength (e.g., an energization state), an attachment field, a polarity, etc. At block 766, the process 760a displays the digital object based on the second attraction properties (via, e.g., a designated color, pattern, shape, etc.).

Referring to FIG. 7B, the second process 760b can be used to detect for attraction between a digital object and a graphical tool based on their corresponding attraction properties. At block 767, the process 760b determines if the digital object has zero attachment strength. As discussed above, a digital object with zero attachment strength will not attach to a graphical tool. At block 768, the process 760b determines if the graphical tool has zero attachment strength, which will also prevent the digital object from attaching. At block 769, the process 760b compares the polarities of the digital object and the graphical tool. When opposite polarity is detected, the object and the tool can repel one another, as discussed above.

At block 770, the process 760b determines if the attachment fields of the digital object and the graphical tool are within range of one another. A digital object that is not within range of a graphical tool will not automatically attach (e.g., snap) to it. In some embodiments, the process 760b can determine whether the attachment fields are in range by comparing display coordinates (e.g., pixel coordinates). The display coordinates can be associated with boundary of an attachment field. In various embodiments, the display coordinates can be calculated based on the location of the object or tool, the magnitude of a corresponding attachment strength, and/or the shape of the object or tool from which the field emanates. Attraction can be detected when the borders of two attachment fields are at least adjacent (e.g., overlapping).

If attraction is ultimately detected, the process 760b displays the digital tool as attached to the graphical tool, as shown at block 771. Otherwise, the process displays the digital tool as detached from the graphical tool, as shown at block 772.

Referring to FIG. 7C, the third process 760c can be used to detect for changes to digital objects and graphical tools. Such changes can include, for example, changes in position, relative position, attraction properties, etc. In some embodiments, these changes can be in response to user input. At block 773, the process 760c detects whether a digital object has been moved on the display area. For example, the process 760c can detect whether the user has flicked a digital object toward a particular graphical tool. At block 774, the process 760c detects whether the attraction properties of a digital object have changed (e.g., from a magnetized state to a de-magnetized state). In some embodiments, a digital object's attraction properties can change in response to an expiration time. For example, as discussed above, expiration can cause a digital object to de-magnetize or change polarity

At block 775, the process 760c detects whether the attraction properties of a graphical tool have changed. For example, the process 760c can detect if a user has energized/de-energized a graphical tool. At block 776, the process 760c detects whether any graphical tools have been added and/or removed from the display area. The addition or subtraction of graphical tools can create different interactions with a digital object that may cause it to detach from a graphical tool and/or attach to a different graphical tool. In some embodiments, users can add and remove graphical tools depending on their desired preferences for managing digital objects.

If a change is detected by the process 760c, the process 760c can return to second process 760b (FIG. 7B) to detect for attraction based on the change (i.e., whether the digital object should be attached/detached to a graphical tool based on the change).

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will be appreciated that specific embodiments of the disclosure have been described herein for purposes of illustration, but that various modifications may be made without deviating from the spirit and scope of the various embodiments of the disclosure. Further, while various advantages associated with some embodiments of the disclosure have been described above in the context of those embodiments, other embodiments may also exhibit such advantages, and not all embodiments need necessarily exhibit such advantages to fall within the scope of the invention. Accordingly, the disclosure is not limited, except as by the appended claims.

1. A method for virtual magnetic management of graphical content at a display device having a display area, the method comprising:
associating one or more first attraction properties with a digital object;
associating one or more second attraction properties with a graphical tool for managing digital objects at the display area;
detecting an attraction between the graphical tool and the digital object based on the first and second attraction properties;
if the attraction is detected, displaying the digital object and the graphical tool as attached to one another; and
if no attraction is detected, displaying the digital object and the graphical tool as detached from one another.

2. The method of claim 1 wherein:
the first attraction properties include a first attachment strength;
the second attraction properties include a second attachment strength;
the detecting includes comparing the first and second attachment strengths; and
the method further comprises
displaying the digital object as having at least one of a color and a pattern indicative of the first attachment strength; and
displaying the graphical tool as having at least one of a color and a pattern indicative of the second attachment strength.

3. The method of claim 2 wherein the detecting includes:
determining a first attachment field based on the first attachment strength;
determining a second attachment field based on the second attachment strength; and
detecting the attraction when the first and second attachment fields are within a predetermined range of one another.

4. The method of claim 1 wherein the detecting includes:
determining a boundary of a first attachment field based on a location of the digital object at the display area;
determining a boundary of a second attachment field based on a location of the graphical tool at the display area; and
determining whether the boundaries of the first and second attachment fields are at least adjacent to one another.

5. The method of claim 4 wherein the detecting further includes detecting movement of the digital object that causes the boundaries of the first and second attachment fields to be at least adjacent to one another.

6. The method of claim 5 wherein the movement is associated with a swipe gesture made on the display area by a user.

7. The method of claim 1, further comprising:
displaying the digital object as attached to the graphical tool;
associating a time value with the digital object;
detecting an expiration of the time value; and
upon the expiration, displaying the digital object as detached from the graphical tool.

8. The method of claim 7, further comprising:
displaying another graphical tool at the display area; and
upon the expiration, displaying the digital object as attached to the other graphical tool.

9. The method of claim 1, further comprising:
displaying another graphical tool at the display area;
detecting a change to an attraction property of the other graphical tool; and
upon detecting the change, attaching the digital object to the other graphical tool.

10. The method of claim 1, further comprising displaying the digital object in the form of a virtual magnet and the graphical tool in the form of a virtual electromagnet.

11. The method of claim 1 wherein:
the first attraction properties include a first attachment strength;
the second attraction properties include a second attachment strength; and
the detecting includes detecting no attraction if at least one of the first and second attachment strengths is zero.

12. The method of claim 1 wherein the detecting includes detecting whether the graphical tool and the digital object repel one another based on the first and second attraction properties.

13. A non-transitory computer-readable storage medium storing instruction that, when executed by a computing system, cause the computing system to perform operations for presenting graphical content at a display area of a display device, the operations comprising:
associating one or more first attraction properties with a digital object, wherein the first attraction properties include a first attachment strength;
associating one or more first attraction properties with a graphical tool for managing digital objects at a display area, wherein the second attraction properties include a second attachment strength;
detecting an attraction between the graphical tool and the digital object based on the first and second attraction properties, wherein detecting the attraction includes comparing the first and second attachment strengths;
if the attraction is detected, displaying the digital object and the graphical tool as attached to one another at the display area; and
if no attraction is detected, displaying the digital object and the graphical tool as detached from one another at the display area.

14. The computer-readable storage medium of claim 13 wherein:
the first attachment strength has a first magnitude;
the second attachment strength has a second magnitude;
the operations further comprise
determining a first attachment field based on the first magnitude,
determining a second attachment field based on the second magnitude, and
detecting the attraction when the first and second attachment fields are within a predetermined range of one another.

15. The computer-readable storage medium of claim 13 wherein:
the first attraction properties further include a first polarity;
the second attraction properties further include a second polarity; and
the detecting further includes comparing the first and second polarities.

16. The computer-readable storage medium of claim 13 wherein the operations further comprise displaying the digital object in the form of a virtual magnet and the graphical tool in the form of a virtual electromagnet.

17. The computer-readable storage medium of claim 16 wherein the operations further comprise:
receiving user input causing de-energization of the virtual electromagnet; and
in response to the user input, displaying the virtual magnet as detached from the virtual electromagnet.

18. The computer-readable storage medium of claim 16 wherein the operations further comprise:
receiving user input causing de-magnetization of the virtual magnet; and
in response to the user input, displaying the virtual magnet as detached from the virtual electromagnet.

19. A computing system comprising a computer-readable storage medium storing instruction that, when executed by the computing system, cause the computing system to perform operations for virtual magnetic management of graphical content, the operations comprising:
displaying a digital canvas at a display area of display device;
receiving input from a user;
displaying a graphical tool on the canvas in the form of a virtual electromagnet that can be selectively activated into an energized state and de-activated into a de-energized state based on the input from the user; and
displaying a digital object on the canvas in the form of a magnet configured to
attach to the electromagnet when in the energized state, and
detach from the electromagnet when in the de-energized state.

20. The computing system of claim 20 wherein the operations further comprise:
displaying the magnet in a magnetized state in which the user can attach the magnet to the electromagnet; and
displaying the magnet in a demagnetized state in which the magnet will not attach to the electromagnet.
